(19) United States
(12) Patent Application Publication
(10) Pub. No.: US 2019/0239542 A1
(43) Pub. Date: Aug. 8, 2019

(54) Filling Machine and Method for the Sterile Filling of a Foodstuff Containing a Main Component and an Additive Component

(71) Applicant: SIG Technology AG, Neuhausen am Rheinfall (CH)

(72) Inventor: Werner Trautwein, Geilenkirchen (DE)

(21) Appl. No.: 16/329,863

(22) PCT Filed: Aug. 30, 2017
(86) PCT No.: PCT/EP2017/071790

§ 371 Date: Mar. 1, 2019

(30) Foreign Application Priority Data
Sep. 5, 2016 (DE) 10 2016 116 529.8

(51) Int. Cl. A23L 3/01; A23L 3/00; B65B 55/14; B65B 3/26; B65B 3/04; B65B 65/00

(52) U.S. Cl. CPC A23L 3/01; A23L 3/001; A23L 3/003; A23V 2002/00; B65B 3/26; B65B 3/04; B65B 65/003; B65B 55/14

(57) ABSTRACT

A filling machine the sterile filling of a foodstuff into a plurality of containers comprising at least one least one main component and at least one additive component with a conveying device for conveying the at least one main component from at least one feed unit to at least one filling outlet of a filling valve. Therefore, foodstuffs comprising at least one main component and at least one additive component can be handled more easily. It is envisaged that there are provided a holding container for the at least one additive component, a metering device Connected to the holding container for the metering of the additive component into the containers and/or to the main component, and an electrical heating device in the metering device for the pasteurisation or sterilisation of the additive component before the metering into the containers and/or to the main component.

The invention relates to a filling machine for the sterile filling of a foodstuff containing at least one main component and at least one additive component into a plurality of containers, in particular cardboard/plastic composite packagings, with a conveying device for conveying the at least one, in particular pasteurised or sterilised, main component from at least one feed unit to at least one filling outlet of a filling valve. Furthermore the invention relates to a system comprising such a filling machine and a processing plant for pasteurising or sterilising the main component and for feeding the pasteurised or sterilised main component to the feed unit of the filling machine. In addition the invention relates to a method for the sterile filling of a foodstuff containing at least one main component and at least one additive component into a plurality of containers, in particular cardboard/plastic composite packagings, with a filling machine.

Filling machines of the aforementioned type serve for the filling of, in particular flowable, foodstuffs into a plurality of containers, in particular packagings. The foodstuffs can for example be beverages such as juices, water or milk. Other foodstuffs such as yoghurt, sauces, dressings and the like are however also be possible. In this connection the foodstuffs can if necessary contain components in the form of particulate fractions, such as for example fruit flesh or vegetable pieces. The foodstuffs in addition often contain additives such as aroma substances, vitamins, components with particulate fractions or colorants, which are added to a main component of the foodstuff. Frequently, different foodstuffs simply differ as regards the additives, whereas the main component that is used is not changed. Thus, for example, various pieces of fruit, colorants and/or aroma substances can for example be added to yoghurt, depending on the desired taste to be achieved.

In order that the foodstuffs can be kept for as long as possible after the filling into the containers, it is necessary to pasteurise or sterilise the foodstuffs before they are filled into the containers. In addition the filling should take place under sterile and aseptic conditions in previously sterilised containers. In this way the foodstuffs can be kept in at least substantially free from germs and microorganisms in the containers.

Containers are in particular packagings for packaging the foodstuff. The packagings are preferably cardboard/plastic composite packagings, which are formed from a packaging material in the form of a laminate including a cardboard layer and outer, in particular thermoplastic, plastic layers, for example of polyethylene (PE). The cardboard imparts a sufficient stability to the packagings so that the packagings can be easily handled and stacked for example. The plastic layers protect the cardboard against moisture and enable the packaging material to be sealed so as to form an impermeable packaging. In addition further layers, such as for example an aluminium layer, can also be provided, which prevent a diffusion of oxygen and other gases through the packaging.

The sterilisation or pasteurisation of the foodstuffs is carried out in a so-called processing plant, from which the sterilised or pasteurised foodstuffs are dispensed to the filling machine. For this purpose the filling machine has a feed unit, which is connected in particular to a storage container. The feed unit can for example be a pipeline or a connecting piece. The corresponding foodstuff is stored in the meantime in the storage container until the filling of the containers takes place. The sterilisation or pasteurisation is generally carried out batch-wise, in which the foodstuff is heated for a certain time at a specific temperature. In this way microorganisms are at least substantially killed, so that a filling of the foodstuff that is as germ-free as possible can take place. The sterilisation is carried out for example at a temperature between 121° C. and 141° C., whereas the pasteurisation can take place at a temperature between 70° C. and 98° C. In the case of relatively acidic products such as fruit juices, the pasteurisation itself can be sufficient to kill microorganisms in sufficient amount. Since the foodstuffs to be sterilised typically contain water, sterilisation takes place under excess pressure, in contrast to pasteurisation. So as not to damage the quality of the foodstuff, the foodstuff is however heated for as short a time as possible and is then cooled. Following this the pasteurised or sterilised amount of foodstuff is conveyed to a storage container of the filling machine.

The storage container is maintained sterile during the filling and is connected via a conveying device to at least one filing outlet, from which the foodstuff is discharged, so as to be received by the packaging placed underneath. In this connection the filling outlet is as a rule formed by a filling valve, which serves for the exact filling of the foodstuff. Typically the filling of the foodstuff is performed via a series of filling outlets and filling valves, all of which can be connected to the storage container. The filling outlets are then as a rule arranged in a row next to one another, the containers being conveyed to the filling outlets also in rows arranged next to one another.

When filling foodstuffs consisting of several components an at least partial de-mixing of the components can occur in the storage container, which can require the use of an additional stirring device in the storage container. However, even then it cannot always be ensured that the components always reach a packaging in the desired ratio to one another. This is the case in particular if the viscosity of the components differs significantly from one another or one component contains particulate fractions, the density of which may differ considerably from the density of the other component. In addition a complicated and costly change of product is necessary also in the case where just the additive component but not however the main component is to be replaced. In order to make it easier to effect a change of product it has already been proposed to sterilise or pasteurise the additive component separately and store it in a holding container separately from the main component. The additive component can then be filled in the packaging via a separate filling valve before or after the main component. This however also involves a not inconsiderable expenditure as regards the processing technology and the apparatus. Thus, the for example one processing plant has to pre-treat different components in succession for the filling, or a separate processing plant has to be provided for the separate components.

The object of the present invention is therefore to organise and develop a filling machine, a system and a method of respectively the aforementioned type, so that foodstuffs containing at least one main component and at least one additive component can be handled more simply.

This object is achieved with a filling machine according to the pre-characterising part of claim 1, characterised in that there are provided a holding container for the at least one additive component, a metering device connected to the holding container for metering the additive component into the containers and/or to the main component, and an electrical heating device in the metering device for pasteurising or sterilising the additive component before it is metered into the containers and/or to the main component.

The object is in addition achieved with a system according to the pre-characterising part of claim 7, characterised in that the filling machine is implemented according to one of claims 1 to 6.

In addition the object is achieved according to claim 8 by a method of the aforementioned type,
in which the at least one, in particular pasteurised or sterilised, main component is conveyed by a conveying device from at least one feed unit to at least one filling valve comprising a filling outlet,
in which the main component is filled by means of the at least one filling valve into the plurality of containers,
in which the at least one additive component is stored in a holding container,
in which the additive component is metered from the holding container and via a metering device into the containers and/or to the main component, and
in which the additive component is pasteurised or sterilised in an electrical heating device of the metering device before it is metered into the containers and/or into the main component.

The invention has recognised that the handling of the at least one additive component can be considerably simplified if the additive component is transferred, not already pasteurised or sterilised, to the filling machine, but instead is first of all stored without already having been pasteurised or sterilised, in at least one holding container. The holding container is accordingly not a storage vessel for the at least one main component, and the holding container is provided with an additional metering device for metering the additive component for the purposes of filling in the containers. In this connection the metering device can be designed to meter the additive component into the containers separately from the at least one main component, if necessary before, after or at the same time together with the main component. Alternatively or in addition the metering device can however also be designed to meter the at least one additive component into at least one main component, before the at least one main component is filled in the containers. The at least one additive component and the at least one main component are therefore separate or are mixed, before the components are jointly filled in containers.

So that no microorganisms are introduced into the at least one main component and/or the containers via the at least one additive component, the at least one additive component is after its removal from the at least one holding container passed through an electrical heating device, in which the additive component is heated until the additive component is pasteurised or sterilised by the heating. Whether a sterilisation or pasteurisation is carried out depends on the additive product, in particular on the pH of the additive product, and is accordingly predetermined. It is particularly preferred however to use additive products that simply have to be pasteurised. This can actually take place at temperatures of less than 100° C. and therefore typically at ambient pressure. The sterilisation of the additive component requires on the other hand higher temperatures, in particular at least 121° C., so that the sterilisation has to be carried out under excess pressure and is therefore more complicated. The pressure of the sterilised additive component can be relieved after the heating and/or during the metering of the additive component into the containers or into the at least one main component.

The use of an electrical heating device has the advantage compared to heating with process steam for example, that the heat output of the heating device can be regulated very precisely and very quickly without any major problem. In this way it can be ensured that the at least one additive component does not come into contact for too long with a hot heat transfer surface, for example between two successive metering events, in which the additive component is metered into the containers and/or into the main component. Otherwise there is the danger in fact that the additive component will burn or the quality of the additive component will otherwise be adversely affected. Too strong or too prolonged a heating of the additive component can be prevented if the output of the electrical heating device is suitably regulated. For example, during an interim plant downtime the voltage supply of the heating device can for example be completely disconnected.

The heating and thus pasteurisation or sterilisation of the additive component instead of the main component in the filling machine is a possibility, since the additive component accounts for a much smaller proportion of the foodstuff to be filled than does the main component. The at least one additive component can consequently be pasteurised with less effort and more reliably than the main component. Nevertheless in principle also a main component can be delivered to the filling machine, without the main component already having been pasteurised or sterilised. An electrical heating device can then be provided in the conveying device through which the main component flows and is thereby pasteurised or sterilised, depending on what is necessary or desired in the particular individual case.

The main component is according to the process conveyed via a conveying device from at least one feed unit, which serves for delivering the main component to the filling machine, to at least one filling valve comprising a filling outlet, from where the main component is filled into containers. If multiple filling outlets or filling valves are provided, these can be connected via a conveying device to a feed unit. Alternatively or in addition the filling valves can also be connected to a common storage container or to separate storage containers. The at least one storage container is then part of the conveying device. The filling valve can fill containers led up in succession to the valve, while multiple filling valves can respectively fill containers led up in particular parallel to one another.

The at least one additive component is first of all stored in a holding container and from there is metered via a metering device into the containers and/or to the main component. Before the metering of the at least one additive component the additive component to be metered passes through an electrical heating device forming part of the metering device, in which the at least one additive component is pasteurised or sterilised. The at least one additive component is therefore like the at least one main component filled separately or together, pasteurised or sterilised, into the containers provided for this purpose, for which purpose the containers are delivered to the corresponding filling valves.

The containers are in particular formed as packagings made from a packaging material for receiving and/or for packaging the foodstuffs. In this connection the packagings are preferably cardboard/plastic composite packagings, which if necessary can be produced in the filling machine from a packaging precursor. For example packaging material blanks of packaging material can be used as packaging precursor, which can be pre-assembled if necessary, and specifically for example by sealing longitudinal edges to form a packaging preform in the form of a packaging sleeve. Corresponding packaging sleeves are typically placed on mandrels of a so-called mandrel wheel, wherein the cross-section of the mandrels corresponds to the internal cross-section of the packaging sleeve, which first of all projects outwardly over the mandrel. This projecting region of the packaging sleeve is heated and to close it, for example as a packaging base, is folded against the front side of the mandrel and pressed there. Since in principle this makes no noticeable difference as regards the procedure for filling packagings, in particular the downwardly pointing, closed part of the packaging during the filing is regarded as the base of the packaging, and in particular the still unclosed upper part of the packagings during the filling is regarded as the top of the packaging. The alignment the packaging when it is handled after the filling and final closure, in other words whether the filling finally takes place from above or from below, is however basically irrelevant as regards the object to be achieved according to the invention. In other words, in this connection it does not make a big difference whether the packagings are filled through the still open base region or through the still open top region of the packagings.

For the filling operation the containers open on one side are delivered to a sterilisation zone of the filling machine, for example by introducing the containers in succession into cells of a transporting device. The containers are then transported with a defined velocity and in a defined spacing with respect to one another through the sterilisation zone, where the containers are if necessary preheated with hot sterile air before a sterilisation of the containers is carried out, for example with hydrogen peroxide, and if necessary drying with sterile air. The sterilised containers are then transferred to the filling and sealing zone and are there preferably filled with a flowable foodstuff, such as for example a beverage. The packaging is then sealed and transported via the transporting device from the filling and sealing zone, and is finally removed from the cells of the transporting device.

In some filling machines the containers, especially in the form of packagings, are transported by the transporting device in a straight line through the filling machine. Corresponding filling machines are also termed long runners. In other filling machines, the so-called carousels, the containers and the packagings describe a more or less arcuate movement, which can include a circular section or several circular sections. In addition the containers can be transported batch-wise or continuously through the filling machine. In any case the transportation of the containers can be halted during the filling. The containers can however also be moved on continuously during the filling, in which case the filling outlet is then preferably moved together with the container.

Preferred embodiments of the filling machine, the system and the method are described jointly hereinafter for the sake of a better understanding and to avoid unnecessary repetitions, without differentiating in detail exactly between the filling machine, the system and the method. However, from the context it will be obvious to the person skilled in the art which features are preferred in each case with regard to the filling machine, the system and the method.

In a first particularly preferred embodiment of the filling machine the at least one electrical heating device is designed for the direct heating of the at least one additive component. The direct heating of the additive component can in fact take place with the avoidance of hot heat transfer surfaces. These actually still continue to dissipate heat to the additive component when this is not at all desirable, for example if the additive component remains for whatever reason in the heating device for longer than originally intended. This can actually damage the quality of the additive component. It can also lead to a “burning” of the additive component, which necessitates the cleaning of the heating device or can lead to an undesirable change in taste of the foodstuff.

The direct heating is in this case preferably carried out by passing an electric current through the additive component to be metered in. The heat is therefore generated directly in the at least one additive component and not necessarily in an additional heating resistor.

The heating up of the additive component can thus be regulated very precisely, and in fact virtually without any delay. The greater the current intensity through the additive component the higher the current density flowing through the additive component, and therefore more heat is generated in the additive component. So that the flow channels coming into contact with the additive component in the heating device do not heat up more than the additive component itself, the flow channels can be formed at least substantially from a non-conductive material.

For the direct heating of the additive component it is in principle preferred if at least two electrodes spatially separated from one another are brought into contact with the additive component, wherein the electrodes are connected to a voltage supply so that an electric current flows between the electrodes, which is conducted through the additive component. In other words, the additive component can for example be understood that the additive component itself forms the heating resistor of the electrical heating device. A heating resistor, which can be formed for example by a heat transfer surface, can if necessary therefore be dispensed with. If necessary also more than two electrodes can be brought into contact with the additive component. Irrespective of the number of electrodes it is particularly preferred, especially for additive components containing particulate fractions, if the electrodes are provided over the surface and/or on an inner wall of the heating device. In principle the electrodes can however also project, for example in the manner of a pin, into the free cross-section of the heating device for the additive component. Particulate fractions could however be trapped on the latter, so that this solution could be preferred in particular for additive components not containing particulate fractions.

The heating device can however alternatively or in addition also have a separate heating resistor, which is coupled in a thermally conductive manner directly or indirectly to the additive component. In this connection relatively little material in addition to the additive component need actually be heated, so that an extremely rapid temperature regulation can be achieved and the thermal inertia of the corresponding system can be reduced. The heating of the additive component should take place as far as possible immediately on connecting the voltage supply and should be stopped again as quickly as possible on disconnecting the voltage supply. This is for example also possible without any heating resistor at all in the form of the additive component and/or of the at least one separate heating resistor.

Thus, the additive component can be heated directly via microwaves and/or radio waves, with which the additive component is irradiated in the heating device. So that the microwaves and/or radio waves are not absorbed too strongly during the irradiation of the additive component, the line conveying the additive component to the heating device can be formed from plastic or glass instead of metal, which furthermore preferably satisfies the thermal requirements. As soon as the additive component is no longer irradiated with microwaves and/or radio waves, a further heating mainly takes place over parts of the plant that are still hot, for example the line for the additive component. Heating devices can also combine microwaves, radio waves and/or heating resistors. In addition a regulating device can be provided, which disconnects the voltage supply to the heating device if no additive component is conveyed through the heating device. The heating device can in this connection be switched by means of a relay or, preferably, via a transistor.

A cooling of the at least one heated additive component is as a rule not necessary, since the additive component flows through relatively narrow flow cross-sections and thereby releases a lot of heat. Consequently the additive component is optionally cooled again shortly after leaving the heating device to a significantly lower temperature, possibly to the initial temperature before the heating. Alternatively or in addition the additive component is metered into the cooler main component and thereby cooled. In this way expenditure is saved as regards structural items and control technology. In addition the main component is not excessively heated by the hotter additive component, which otherwise could lead to a deterioration of the quality of the foodstuff. The additive component in fact preferably accounts for a significantly smaller proportion of the foodstuff than does the main component.

For the metering of the additive component to the main component the metering device is connected for example to the conveying device, in particular to a filling valve or a valve cluster, to which multiple filling valves are connected. The valve cluster is in this connection the interface between the filling machine and the material supply, which can be a plant heating the main component to ultra-high temperatures. Such a plant can if necessary supply multiple filling machines with the main component. This allows a rapid cooling of the additive component and a good intermixing of additive component and main component. In particular if the additive component and the main component are readily miscible, it may also be advantageous to connect the metering device to a storage container for the main component. The additive component and the main component can then be mixed in the storage container and/or on the route to the filling outlet along the conveying device.

Alternatively the at least one additive component can however also be metered separately from the main component directly into the containers. A merging of additive component and main component is then not necessary. Also, it can thus be ensured that always the correct amount of additive component reaches the containers. The direct metering of the additive component into the containers can take place as desired before, after and/or during the filling of the at least one main component. The filling of the additive component before or during the main component can lead to a better intermixing. The subsequent metering of the at least one additive component after the at least one main component, if necessary also the prior metering of the additive component, may on the other hand be preferred for example if no intermixing of additive component and main component is desired, for instance in the case of yoghurt with a separate fruit preparation. One possibility for the separate metering of the additive component is to provide at least one separate filling valve with a filling outlet for this purpose. If the metering is to take place in parallel in multiple containers, then correspondingly many filling valves can be arranged in parallel.

In order to ensure a sterile filling of the containers, the at least one filling valve and/or the at least one filling outlet for the main component and/or the additive component can be assigned to an aseptic zone of the filling machine, which is free of microorganisms. It is particularly preferred in this case if the at least one filling valve projects at least partly into the aseptic zone and/or the at least one filling outlet is arranged in the aseptic zone.

In order to avoid an overheating of the additive component, whether it be during normal intended use and/or if an operational malfunction occurs, a plant controller can be provided, which permits a discontinuous heating of the additive component to be metered in. The heat output can then be discontinued for example in the case of an operational malfunction, in which no further metering of the additive component takes place. Alternatively or in addition such an interruption can however also take place during normal intended use. For example, the additive component can then only be heated, by passing current through the additive component, if the additive component is transported through the heating device. If this is not the case, for example if the metering of the additive component takes place batch-wise and/or intermittently, the heating of the additive component to be metered in can be stopped during the time when the additive component is not transported through the heating device. A specific metering interval can also be set, which if exceeded leads to an at least partial or temporary switching off of the heating device. The at least one additive component is thereby prevented from being heated for too long and/or too strongly.

Especially for the finishing and processing of main components by the addition of additive components in the form of aroma substances, vitamins and certain other additives, it is preferred if only a very small amount of additive component is metered in. This can be a so-called micro-dosing. Preferably between 0.1 vol. % and 2 vol. %, in particular simply between 0.1 vol. % and 1 vol. %, of the overall filled foodstuff is metered in as additive component. These particularly small amounts are in principle difficult to handle. As a result of the separate metering and the separate pasteurisation or sterilisation in the heating device the handling of such small amounts of additive component can be improved and simplified.

Particularly preferred are the method and the filling machine for additive components that have a significantly smaller proportion of foodstuffs than do the main components. In this case the handling and the pasteurisation or sterilisation of the additive components is actually simple and reliable. Particularly preferred are additive components that make up at least 2 vol. %, in particular at least 4 vol. %, of the total foodstuff to be filled. Alternatively or in addition it is preferred if the proportion of the additive component makes up at most vol. %, in particular at most vol. %, of the overall amount of the foodstuff to be filled. Larger proportions of the additive component can lead to a pasteurisation or sterilisation that is not always reliable.

As additive component there may be mentioned at least one aroma substance, at least one vitamin (e.g. ascorbic acid/vitamin C) or a vitamin composition, at least one colorant, at least one component containing particulate fractions, at least one component with a viscosity that at 20° C. is at least ten times, in particular 100 times, higher than that of the main component. The viscosity is in this connection preferably determined by means of a standardised method, for example according to DIN 53019 using a rotary viscosimeter. It may be particularly preferred to use a cylinder rotary viscosimeter, a cone-and-plate rotary viscosimeter or a plate rotary viscosimeter. In the comparison measurements the same viscosimeter should be used with the same adjustments and in the same way, in particular at the same temperature. Corresponding additive components can for example be fruit juice concentrates or the like. In principle also those items that contribute significantly more intrinsic value or worth than the main components are suitable as additive components. Also suitable however as additive components are those items that differ significantly as regards their properties from the main components, so that for example there is the danger of an at least partial de-mixing of main component and additive component. Alternatively or in addition the mixing of additive component and main component itself can however also be complicated on account of the differences in properties. By metering the additive component for example to the main component or separately to the packaging, the danger of a de-mixing can be reduced and/or the mixing can be simplified.

Suitable as main component are in particular fruit juices, milk or water. Many different additive components can be added to such foodstuffs that have a significant influence on the properties, taste and the intrinsic value of the finished foodstuff. In principle however other foodstuffs are also suitable as main components.

In order to simply pasteurise and not to have to sterilise the additive component, it is convenient for example if a highly acidic component having a pH of at most 4.5 is used as additive component. Accordingly acidic additive components can for example be juice-based, acidified milk product-based or tea-based foodstuffs. In principle it is preferred in this connection if the additive component is heated in the heating device to at least 100° C., preferably between 70° C. and 95° C. The necessary heat treatment can then also be carried out in the case of aqueous foodstuffs at ambient pressure instead of excess pressure.

However, a component that is at most slightly acidic with a pH of at least 4.5 can also be used as additive component. The use of such a component can in many cases be simplified by the filling machine and the method. The additive component is then preferably sterilised and/or heated in the heating device to at least 121° C., in particular between 121° C. and 131° C. This is sufficient in order to be able to use the additive component without this leading to any noticeable adverse effects as regards the shelf life of the filled foodstuff.

The temperature during the filling of the foodstuff should not be too high, so that the quality of the filled foodstuff does not unnecessarily suffer. The temperature of the foodstuff after the mixing of at least one main component with at least one additive component, in particular during the filling into the containers, can therefore be less than 30° C., in particular between 4° C. and ° C. Alternatively or in addition the additive component and the main component can be conveyed separately into the packaging, and specifically if necessary in each case at a temperature of less than ° C., in particular between 4° C. and 25° C.

In order to maintain the specified temperature the volume and/or the weight proportions as well as the temperature of respectively the main component and the additive component can be correspondingly matched to one another. The previously specified temperatures should be adjusted as uniformly as possible within as far as possible 60 seconds or 30 seconds after the closing of the container or alternatively during the closing of the container.

The invention is described in more detail hereinafter with the aid of drawings simply illustrating exemplary embodiments, and in which:

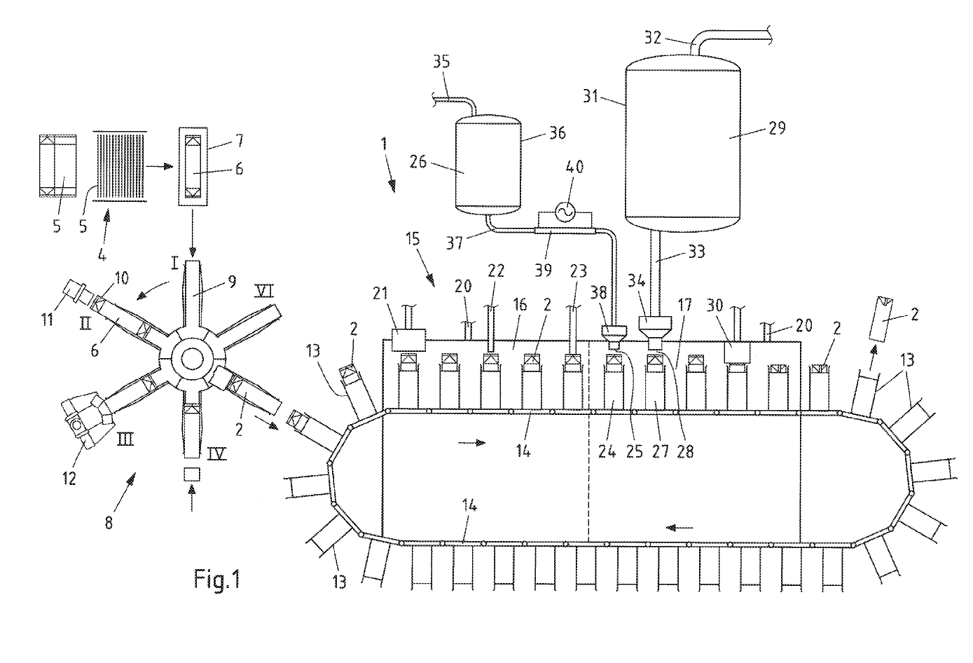

FIG. 1 shows a schematic representation of a first filling machine according to the invention,

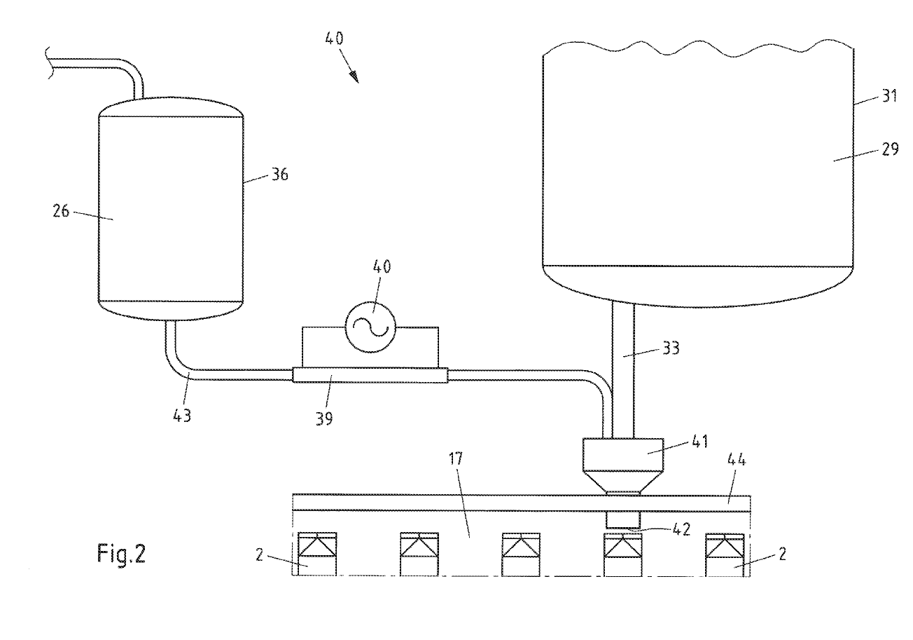

FIG. 2 shows a schematic representation of a detail of a second filling machine according to the invention,

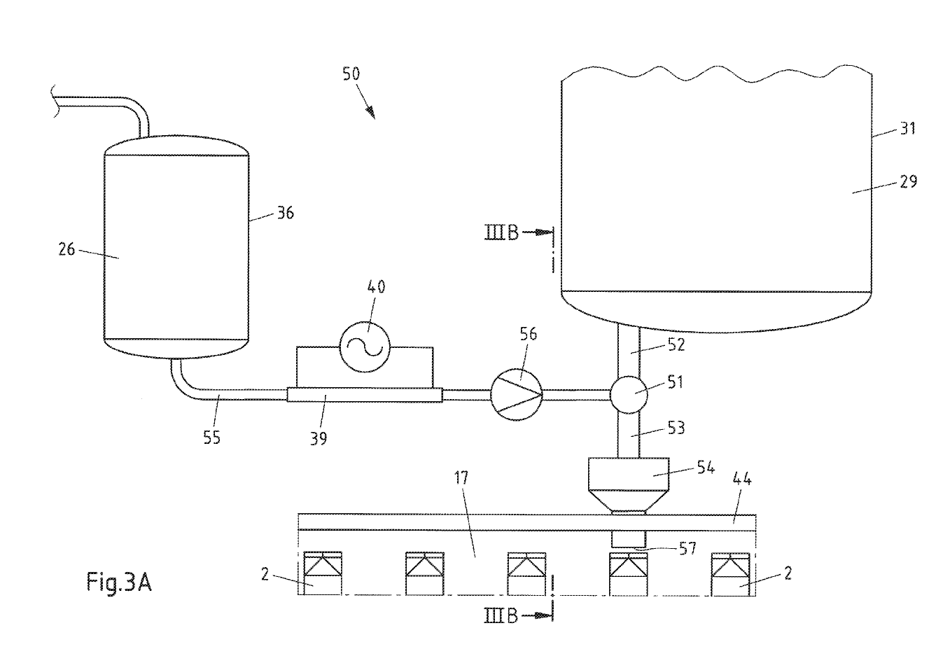

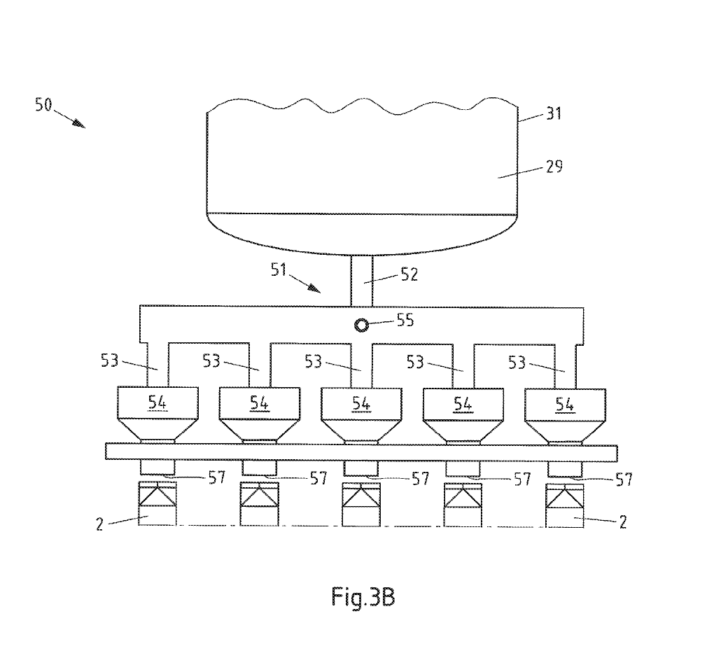

FIG. 3A-B shows a schematic representation of a detail of a third filling machine according to the invention, and

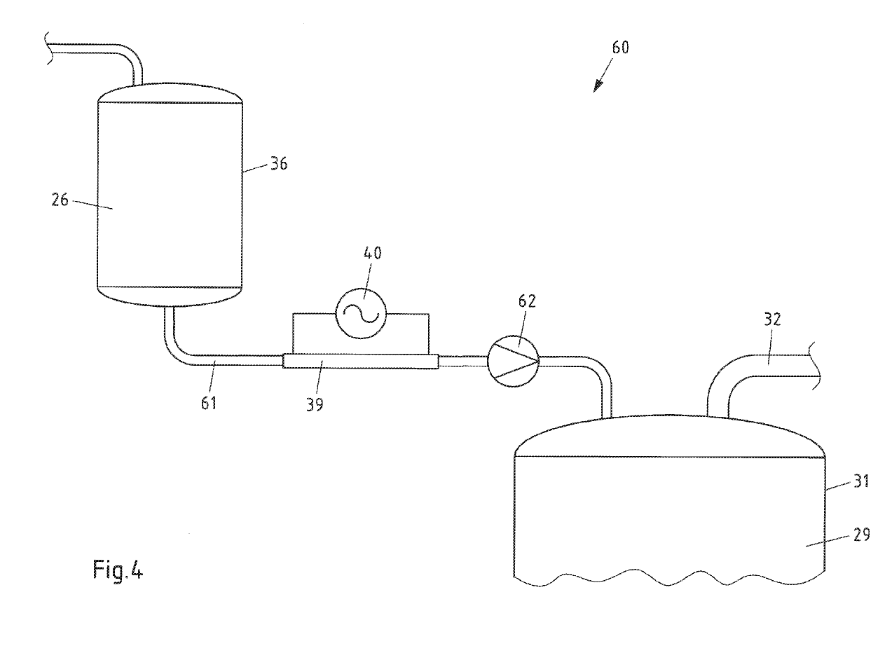

FIG. 4 shows a schematic representation of a detail of a fourth filling machine according to the invention.

In FIG. 1 a filling machine 1 is illustrated for filling containers 2 in the form of packagings, preferably cardboard/plastic composite packagings, in particular with flowable foodstuffs, comprising a device 3 for forming and shaping the containers 2. Alternatively these or other containers could however also be produced in a different way and conveyed to the filling machine 1. The illustrated and in this respect preferred filling machine 1 has a series of parallel processing lines, simply one processing line of which is illustrated in FIG. 1. A bundle 4 of packagings preforms in the form of packagings blanks is associated with each processing line, the longitudinal edges of the blanks being sealed to one another and thereby forming packaging sleeves 6, which are delivered folded together. The packaging sleeves 6 are unfolded by means of a feed device 7, wherein an application device can also be provided if necessary for applying pouring means, not illustrated, to the packaging sleeves 6.

The device 3 for forming and shaping the containers 2 has a mandrel wheel 8, which in the illustrated and in this respect preferred case comprises six mandrels 9 and rotates cyclically, i.e. stepwise, in an anti-clockwise direction. In the first mandrel wheel position I a packaging preform in the form of a packaging sleeve 6 is slid onto the mandrel 9. The mandrel wheel 8 is then turned to the next mandrel wheel position II, in which the end region of the packaging sleeve 6 projecting beyond the mandrel 9 is heated with hot air by means of a heating unit 11. In the next mandrel wheel position III the heated end region of the packaging sleeve 6 is pre-folded by a press 12 and in the following mandrel wheel position IV is tightly sealed in the folded position by a sealing device, not identified in more detail, to form in particular a base. A container closed on one side is obtained in this way, which in the following mandrel wheel position V is removed from the mandrel 9 and is transferred to a cell 13 of a circularly guided, endless transporting device 14. No work step is associated with the mandrel 9 in the next mandrel wheel position VI. The number of mandrel wheel positions and mandrels and the processing steps envisaged there can if necessary vary from the representation according to FIG. 1 and the relevant description.

The container 2 is transported with the open end pointing upwards in an associated cell 13 of the transporting device 14 in the form of a transport chain through the filling machine 2. If necessary also the containers 2 could be filled through the upwardly pointing base region, if the downwardly pointing head region is closed for this purpose. The container 2 passes to an aseptic chamber 15, which includes a sterilisation zone 16 and a filling and sealing zone 17, through which the container 2 is transported from left to right in the transporting direction symbolised by the arrows.

The illustrated and in this regard preferred filling machine 1 is formed as so-called long runner, since the containers 2 are conveyed at least substantially rectilinearly through the filling machine. The transportation of the containers 2 need not take place rectilinearly, but can also take place in at least one arc or even circularly. Such filling machines are also termed carousels, since the containers are then for example moved at least over some sections along a circular path. In this case at least some parts of the filling machine can rotate about a central axis, which can coincide with the axis of the circular path of the containers.

Sterile air is fed to the aseptic chamber through corresponding sterile air connections 20. The containers 2 are preheated in succession by a preheating device 21 that blows in hot sterile air. The containers 2 are then sterilised by means of a sterilisation device 22, preferably by means of hydrogen peroxide, following which the containers 2 are dried by blasting with sterile air via a drying device 23, and after being transferred from the sterilisation zone 16 to the filling and sealing zone 17 are brought to a filling position 24 underneath a filling outlet 25. There the containers 2 in the form of packagings are filled in succession with a specific amount of an additive component 26 of a foodstuff. The partially filled containers 2 are then transported to a further filling position 27 underneath a further filling outlet 28, where a main component 29 of the foodstuff is filled in the already partially filled containers 2 in the form of packagings. The containers 2 now filled with the foodstuff are then closed with a closing device by folding and sealing an upper region of the containers 2. The containers 2 are then removed from the cells 13 of the transporting device 14. The now empty cells 13 are moved with the transporting device 14 further in the direction of the mandrel wheel 8, in order to receive further containers 2 there.

The main component 29, which in particular is a highly acidic component in the form of a fruit juice or a yoghurt, is temporarily stored in the filling machine in a storage container 31. In this connection the main component is previously pasteurised or sterilised in a processing plant, not illustrated. The then pasteurised or sterilised main component 29 is next dispensed from the processing plant to the filling machine 1 and is held there in the storage container 31, from where the main component 29 is filled in portions into the containers 2. For this purpose the filling machine 1 has a feed unit 32 for feeding pasteurised or sterilised main component 29. This feed unit can be a line connection, a connecting piece or the like. The main component 29 is conveyed from the feed unit 32 via a conveying device 33 to a filling valve 34, which comprises the filling outlet 28 for filling the containers 2 with the main component 29.

The additive component 26, which together with the main component 29 forms the filled foodstuff, is conveyed separately via a further feed unit 35 to a holding container 36, where the additive component 26 is temporarily stored before it is filled into the containers 2. The additive component 26 passes from the holding container 36 through a metering device 37 to a filling valve 38, which comprises the filling outlet 25, in order to fill the additive component 26 separately from the main component 29 into the containers. On the path from the holding container 36 to the filling valve 38 the additive component 29 passes through an electrical heating device 39 for heating the additive component 26 before the filling of the additive component 26 into the containers 2. By means of the heating in the heating device 39 the additive component 26, which is held unpasteurised or unsterilised in the holding container 36, is then pasteurised or sterilised.

The heating device 39 is connected to a voltage supply 40, which applies a potential difference to at least two electrodes, not illustrated. The electrodes are in conductive contact with the additive component 26, so that the current path between the electrodes is closed by the additive components 26. In other words, an electric current flows from at least one electrode to at least one other electrode of the heating device 39, the additive component 26 acting as a heating resistor. The electric current flowing through the additive component 26 leads to a direct heating without the need for heated heat transfer surfaces to release the heat to the additive components.

The filling of the containers 2 with additive components 26 and main component 29 can be carried out in a different way. If the additive components 26 and main components 29 do not contain any particulate fractions, a plunger can be integrated in the filling valve 34, 38, which by a corresponding displacement forces at intervals a predetermined volume from the filling valve. If the additive component 26 and/or the main component 29 contains particulate fractions, then preferably a piston pump, membrane pump or the like is used in order to dispense the predetermined volume into the containers 2 in a reproducible regular manner. Against this background, here for the sake of simplicity only the filling valves are shown since the additive component 26 as well as the main component 29 can contain particulate fractions and can also be free from particulate fractions. The heating of the additive component 26 for the purposes of pasteurisation or sterilisation in the heating device 39 is envisaged independently of any particulate fractions.

The illustrated filling machine 1 can be designed so that multiple, in particular parallel, rows of containers 2 are transported through the filling machine 1 in order to fill multiple containers 2 in parallel simultaneously. Then multiple filling valves 34, 38 for the additive component 26 and/or the main component 29 are preferably provided, which can be arranged next to one another transversely to the transporting direction of the containers 2. The filling valves 34, 38 are then preferably connected to the same holding container 36 and/or to the same storage container 31. Furthermore a single heating device 39 can be provided, which pasteurises or sterilises the additive component 26 for the filling by the filling valves 38. It can also be envisaged that a separate heating device 39 is associated with each filling valve 38 for filling the additive component 26. Each heating device 39 then pasteurises or sterilises the additive component 26 filled from a filing valve 38.

It is not shown furthermore that the main component 29 can also be filled in multiple individual portions successively into the containers 2 via multiple filling valves 34 arranged one after the other. This is recommended in particular with main components 29 that tend to exhibit foam formation. Due to the filling of the main component 29 in portions less foam is produced and/or the foam has more time so as to break down again. The foam formation does not really play a role in the filling of the additive component 26, since the additive component 26 forms only a minor proportion of the foodstuff filled into the containers 2. This is all the more the case if the additive component is filled before the main component into the still empty containers 2. Specifically then the foam formation can be considerably reduced compared to the foam formation to be expected if the main component and additive component are simultaneously filled. In principle the additive component can however also be filled after the main component 29 into the containers 2. In the case of the portion-wise filling of the containers 2 with the main component 29 it may also be envisaged that the additive component 26 is filled into the containers 2 between two portions of the main component 29.

A detail of an alternative filling machine 40 is illustrated in FIG. 2, in which the additive component 26 from the holding container 36 together with the main component 29 from the storage container 31 are filled via a common filling valve 41 and a common filling outlet 42 into the containers 2. In this case the metering device 43 is connected to the corresponding filling valve 41. The metering device 43 has however an electrical heating device 39 as described above. On passing through the electrical heating device 39 the additive component 26 is pasteurised or sterilised depending on the corresponding requirements, in order then to be mixed with the already pasteurised or sterilised main component 29, wherein the additive component is strongly cooled so that the heating of the additive component 26 in the heating device 39 leads to only a slight loss of quality. The filling valve 41 is designed so that the additive component 26 and the main component 29 are always mixed with one another in the correct ratio. If necessary at least one metering pump can be used for this purpose, which if necessary can be integrated into the filling valve. It is not shown that also in the case of this filling machine 40 multiple filling valves 41 of the aforementioned type can be arranged in a row, in order to fill simultaneously multiple containers 2 and/or to fill the containers 2 in succession portion-wise with the main component 29.

The illustrated filling valves pass through a perforated metal sheet 44, which closes off the aseptic zone upwardly, through which however a curtain of sterilised air can be conveyed downwardly through the holes into the aseptic zone in the filling and sealing zone 17. An in particular laminar and downwardly directed flow of sterilised air is thereby produced, which prevents microorganisms being able to penetrate the filling and sealing zone 17 or the aseptic zone, so that these would no longer be aseptic.

A detail of a further filling machine 50 is illustrated in FIG. 3A-B, in which the main component 29 is taken from the storage container 31 and is distributed via a distributor 51 into various partial streams. For this purpose the conveying device 52 branches from the distributor 51 into a series of partial lines 53, in order to convey the main component 29 to multiple separate filling valves 54, which respectively fill other containers 2. The filling valves 54 are arranged adjacent to one another in a row. Different rows of containers 2 are arranged underneath the filling valves 54 in the transporting direction of the transporting chain 14. In the illustrated and in this regard preferred filling machine 50 five containers 2 are thus simultaneously filled in each filling cycle. Alternatively also more or fewer containers 2 can be simultaneously filled or more or fewer filling valves 54 can be arranged adjacent to one another. The additive component 26 is removed from the holding container 36 via the metering device 55 and is passed through the electrical heating device 39, whereby the additive component 26 is pasteurised or sterilised. The pasteurised or sterilised additive component 26 is then metered in the distributor 51 via a metering pump 56 in a predetermined ratio into the main components 29, wherein the additive component 26 and the main component 29 mix and thereby form the foodstuff to be filled. The foodstuff is then filled as described above via the filling valves 54 and their filling outlets 57 into the containers 2.

A filling machine 60 is illustrated in FIG. 4, in which the additive component 26 is metered from the holding container 36 via a metering device 61 comprising an electrical heating device 39, whose electrodes are connected to a voltage supply 40, into the storage container 31 for the main component 29. The main component 29 is fed, already pasteurised or sterilised, via a feed unit 32. The additive component 26 is pasteurised or sterilised on flowing through the heating device 39. A metering pump 62 is provided in order to meter the additive component 26 in the correct ratio into the main component 29.

1. A filling machine for the sterile filling of a foodstuff into a plurality of containers, the filling machine comprising at least one main component, at least one additive component, and a convyeing device for conveying the at least one main component from at least one feed unit to at least one filling outlet of a filling valve,
wherein there are provided a holding container for the at least one additive component, a metering device connect to the holding container for the metering of the additive component into at least one of the containers or the main component, and an electrical heating device in the metering device for the pasturisation or sterilisation of the additive component before the metering into at least one of the containers or the main component,
wherein the heating device is an electrical heating device configured to pass an electric current through the additive component to be metered so as to directly heat the additive component, and
wherein a plant control is provided for the discontinuous heating of the additive component to be metered, so if the additive component is transported through the heating device or a plant control is provided for interrupting the heating of the additive component to be metered in, then the additive component can only heated by passing through the additive component.

2. A filling machine according to claim 1, wherein the electrical heating device is configured to pass an electric current through the additive component to be metered so as to directly heat the additive component by dispensing with hot heat transfer surfaces.

3. A filling machine according to claim 1, wherein the metering device for metering the additive component to the main component is connected to at least one of the conveying device or to a storage container for the main component.

4. A filling machine according to claim 1, wherein the metering device for metering the additive component separately from the main component into a plurality of containers is connected to a filling valve comprising a filling outlet.

5. A filling machine according to claim 1, wherein at least one of the at least one filling valve, the at least filling outlet for the sterile filling of the main component, for the additive component is associated with an aspetic zone.

6. (canceled)

7. A system comprising a filling machine according to claim 1 and a processing plant configured for the pasteurisation or sterilisation of the main component and for conveying the pasteurised or sterilised main component to the feed unit of the filling machine.

8. A method for the sterile filling of a foodstuff into a plurality of containers, wherein the foodstuff comprises at least one main component and at least one additive component using at least one filling machine according to claim 1, the method comprising:
conveying at least one main component from at least one feed device to at least one filling valve comprising a filling outlet,
filling the main component into the plurality of containers via the at least one filling valve,
storing the at least one additive component in a holding container,
metering the additive component from the holding container and via a metering device into at least one of the containers or the main component,
flowing electric current through and directly heating the additive component to be metered in the electrical heating device, and
heating the additive component discontinously, so that, if the additive component is transported through the heating device or the heating of the additive component is interrupted, then the additive component can then only be heated by passing current through the additive component.

9. The method according to claim 8, further comprising flowing electric current through and directly heating the additive component to be metered in the electrical heating device dispensing with hot heat transfer surfaces.

10. (canceled)

11. The method according to claim 8, wherein between 0.1 vol. % and 2 vol. % of the overall filled foodstuff is metering in as additive component.

12. The method according to claim 8, in which at least 2 vol. % of the overall filled foodstuff is metered in as additive component.

13. The method according to claim 8, in which at least one of at least one aroma substance, at least one colorant, at least one component containing particulate fractions, or at least one component with a viscosity that, at 20° C., is at least ten times greater than that of the main component, is metered in as additive component.

14. The component according to claim 8, in which a highly acidic component with a pH of at most 4.5 is used as additive component, wherein the additive component is pasteurised or heated in the heating device to at most 100° C.

15. The method according to claim 8, in which a slightly acidic component with a pH of at least 4.5 is used as additive component, wherein the additive component is sterilised or heated in the heating device to at least 121° C.

16. The method according to claim 8, in which, after the mixing of at least one main component with at least one additive component, the temperature of the foodstuff is less than 30° C.
